(19) United States
(12) Patent Application Publication
(10) Pub. No.: US 2024/0365721 A1
(43) Pub. Date: Nov. 7, 2024

(54) TELESCOPIC HANDLE PRUNING TOOL

(71) Applicant: HUI-HSIN CHENG, Changhua County (TW)

(72) Inventor: HUI-HSIN CHENG, Changhua County (TW)

(21) Appl. No.: 18/648,465

(22) Filed: Apr. 28, 2024

(30) Foreign Application Priority Data
May 2, 2023 (TW) 112204174

(51) Int. Cl. A01G 3/08; B25G 1/04

(52) U.S. Cl. CPC A01G 3/081; B25G 1/04

(57) ABSTRACT

A telescopic handle pruning tool includes two handles and each handle includes a first tube and a second tube pivotally interconnected to each other. The first tube has a storage portion which has a first hole and a second hole. The second tube includes multiple adjustment holes. A control assembly is located in the storage portion and includes an actuating piece which is pivotably connected to the storage portion. A positioning member and a resilient member are respectively connected to two ends of the actuating piece. The positioning member extends through the second hole of the storage portion. When the actuating piece is pivoted, the positioning member is engaged with or disengaged from one of the adjustment holes of the second tube when pivoting the actuating piece. The first tube is movable relative to the second tube to adjust the length of the handles.

### FIELD OF THE INVENTION

The present invention relates to a horticultural tool, and more particularly, to a telescopic handle pruning tool.

### BACKGROUND OF THE INVENTION

The conventional horticultural pruning tools are classified into various styles according to different uses. There are pruning shears for trimming tree branches, hedge clippers for shaping low shrubs into hedges, and deadwood clippers for cutting deadwood under high pressure, among other types. Typically, these tools include two handles and two blades to provide cross-cutting functionality. However, most pruning tools are of fixed size and cannot be adjusted in length, which makes it inconvenient when pruning branches in high or distant places. Consequently, many manufacturers have started developing pruning tools with adjustable lengths.

However, commonly used adjustable-length pruning tools mostly consist of an outer tube and an inner tube pivotally assembled, and then integrated into one unit using a stamping process. Although the stamping process offers rapid assembly and mass production benefits, various factors such as pressure setting, temperature setting, and even the materials of the assembled objects themselves in the manufacturing process can easily lead to assembly errors, resulting in damaged assembled objects that cannot be used. Moreover, if one component is damaged, it not only affects other assembly processes but also damages other assembled components. Therefore, the horticultural pruning tools produced by the stamping process have a low yield, and once the components are damaged, they cannot be reused, leading to high costs.

The main purpose of the present invention is to provide pruning tools with telescopic functionality by assembling individual components, thereby improving the shortcomings such as susceptibility to damage and low yield caused by the use of stamping processes known in the prior art.

### SUMMARY OF THE INVENTION

The present invention relates to a telescopic handle pruning tool and comprises two handles pivotably connected to each other. Each handle has a first tube and a second tube pivotally interconnected to each other. The first tube has a storage portion located at a first end thereof, and the storage portion includes a first hole and a second hole. The second tube includes multiple adjustment holes. When the second tube is telescopically moved within the first tube, each adjustment hole of the second tube is correspondingly positioned with the second hole of the storage portion. A control assembly is located in the storage portion of the first tube and includes an actuating piece. A pivot seat is disposed in the first hole of the storage portion. A positioning member is connected to a first end of the actuating piece and extends through the second hole of the storage portion. When a second end of the actuating piece is pressed downward, the first end of the actuating piece drives the positioning member to move up and down, such that the positioning member is engaged with or disengaged from one of the adjustment holes of the second tube.

Preferably, a sleeve is positioned between the first tube and the second tube, and has a first orifice and a second orifice. A base of the pivot seat is inserted into the first orifice, and the positioning member is inserted into the second orifice, such that the sleeve and the base of the pivot seat are mutually engaged and immovable.

Preferably, a restriction member is positioned between the first tube and the second tube. The restriction member is located at one end of the second tube. The restriction member has a boss corresponding to a limiting hole of the second tube. The boss of the restriction member is mutually engaged with the limiting hole of the second tube so that the restriction member and the second tube are moved together.

Preferably, the actuating piece includes a linking end and a pressing end respectively formed to the first end and the second end of the actuating piece. A resilient member is located at the pressing end of the actuating piece. A rod is located at the linking end of the actuating piece and connected to the positioning member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded of the telescopic handle pruning tool of the present invention;

FIG. 2 is an assembled perspective view of the handle of the telescopic handle pruning tool of the present invention;

FIG. 3 is a cross sectional view, taken along line III-III of FIG. 2;

FIG. 4 is a sectional cross sectional view to show that the actuating piece is pivoted, and the positioning member is disengaged from the adjustment hole;

FIG. 5 is a cross sectional view to show that the second tube is moved along the direction “A” relative to the first tube;

FIG. 6 is a cross sectional view to show that the second tube is moved along the direction “B” relative to the first tube, and

FIG. 7 is an assembled perspective view of a preferred embodiment of the present invention.

### DETAILED DESCRIPTION OF THE PREFERRED EMBODIMENT

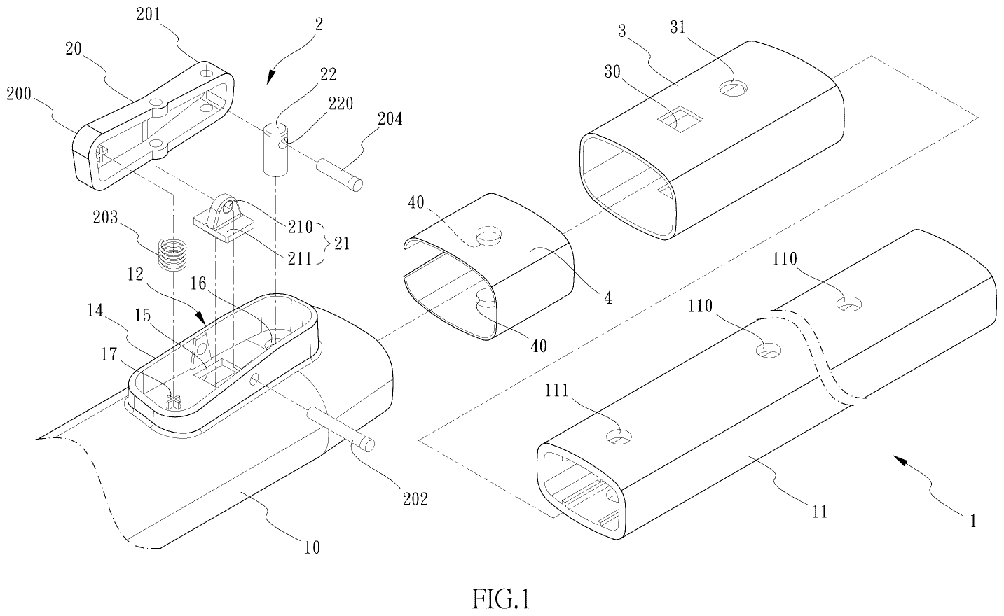

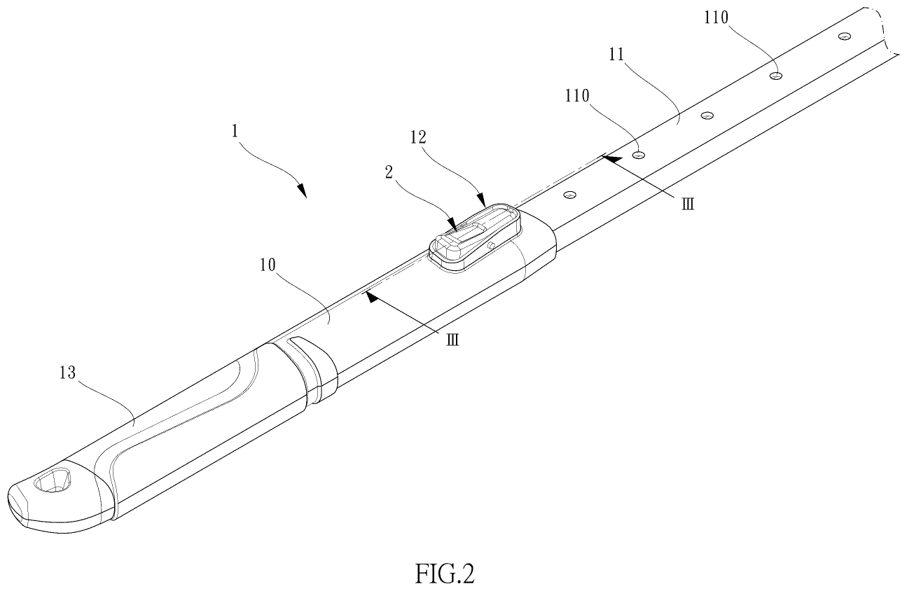

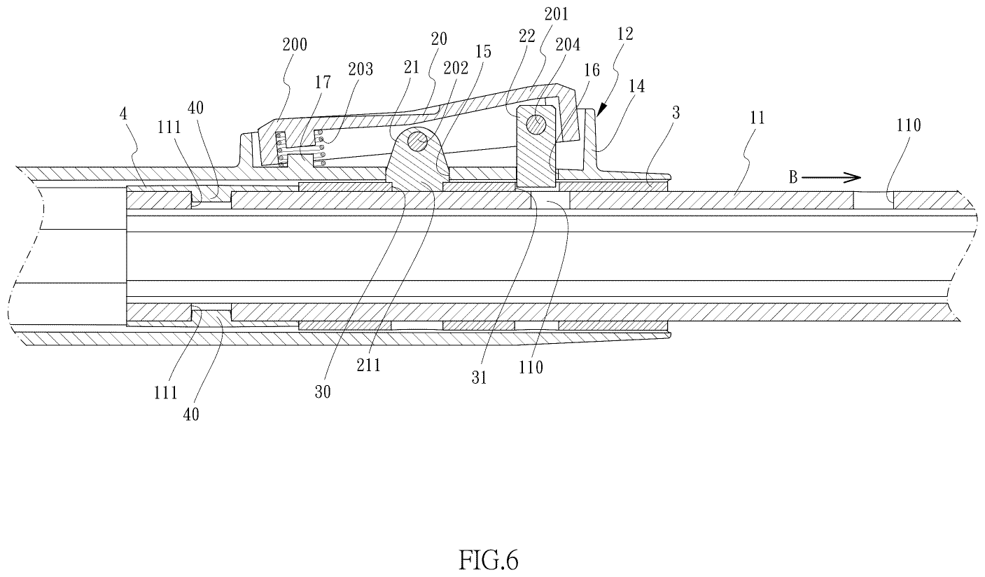

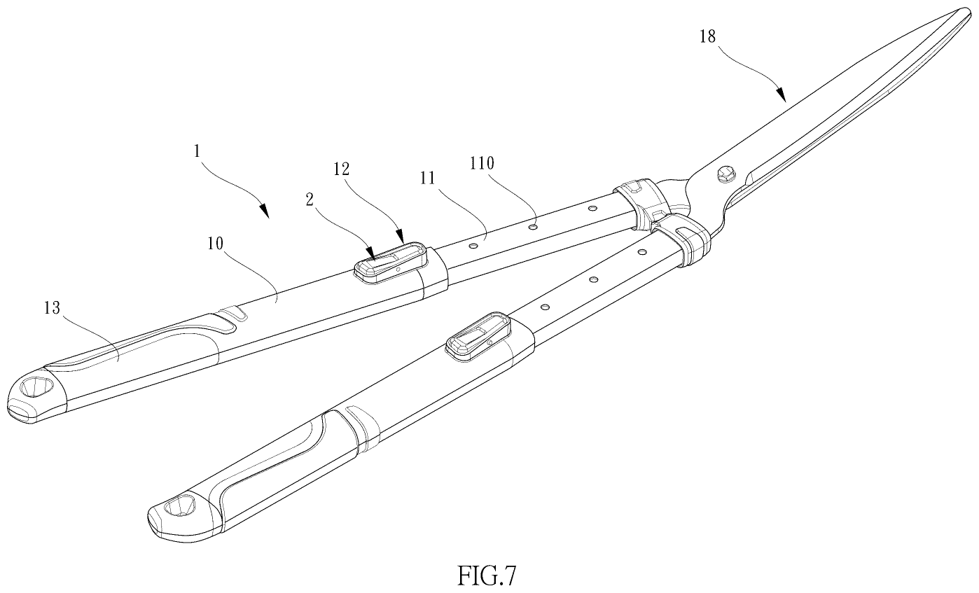

Referring to FIGS. 1 to 7, the A telescopic handle pruning tool of the present invention comprises two handles (1) pivotably connected to each other. Each handle (1) having a first tube (10) and a second tube (11) pivotally interconnected to each other. The first tube (10) has a storage portion (12) located at a first end thereof, and the storage portion (12) is surrounded by a rib (14) and has a protrusion (17). The storage portion (12) further includes a first hole (15) and a second hole (16). The second tube (11) includes multiple adjustment holes (110). The first tube (10) includes an end piece (13) located at the second end thereof and opposite to the first end of the first tube (10). One end of the second tube (11) is connected to a pruning tool (18). When the second tube (11) is telescopically moved within the first tube (10), each adjustment hole (110) of the second tube (11) is correspondingly positioned with the second hole (16) of the storage portion (12).

A control assembly (2) is located in the storage portion (12) of the first tube (10) and includes an actuating piece (20). The actuating piece (20) includes a linking end (201) and a pressing end (200) respectively formed to the first end and the second end of the actuating piece (20). A pivot seat (21) is disposed in the first hole (15) of the storage portion (12), and includes a base (211) from which a protrusion extends and includes a pivot hole (210). A pivot (202) extends through the rib (14) of the storage portion (12), the middle of the lateral wall of the actuating piece (20), and the pivot hole (210), so that the actuating piece (20) is pivotable about the pivot (202). A positioning member (22) is connected to the linking end (201) of the actuating piece (20) and movably extends through the second hole (16) of the storage portion (12). The positioning member (22) has a passage (220) defined radially therethrough, and a rod (204) extends through the linking end (201) of the actuating piece (20) and the passage (220). A resilient member (203) is located at the pressing end (200) of the actuating piece (20), one end of the resilient member (203) is connected to the protrusion (17) of the storage portion (12). In this embodiment, the resilient member (203) is a retractable spring.

A sleeve (3) is positioned between the first tube (10) and the second tube (11). The sleeve (3) has a first orifice (30) and a second orifice (31). The base (211) of the pivot seat (21) is inserted into the first orifice (30), and the positioning member (22) is inserted into the second orifice (31), such that the sleeve (3) and the base (211) of the pivot seat (21) are mutually engaged and immovable.

A restriction member (4) is positioned between the first tube (10) and the second tube (11). The restriction member (4) is located at one end of the second tube (11), and the restriction member (4) has a boss (40) corresponding to a limiting hole (111) of the second tube (11). The boss (40) of the restriction member (4) is mutually engaged with the limiting hole (111) of the second tube (11) so that the restriction member (4) and the second tube (11) are moved together.

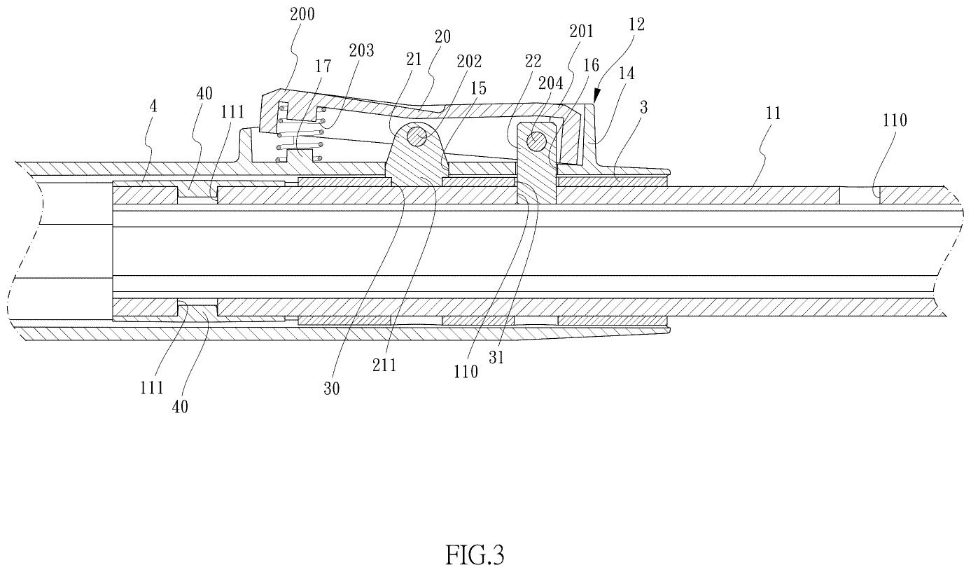

In operation, when the pressing end (200) of the actuating piece (20) is not pressed downward, the positioning member (22) extends through the second hole (16) and is limited by one of the adjustment holes (110) of the second tube member (11) so as to prevent the first tube (10) and the second tube (11) from telescopic movement as shown in FIG. 3.

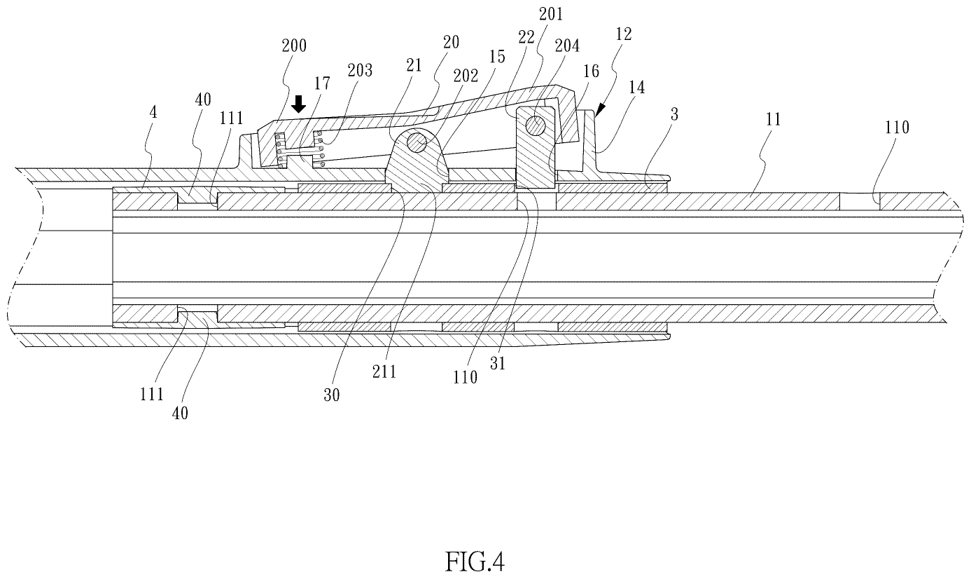

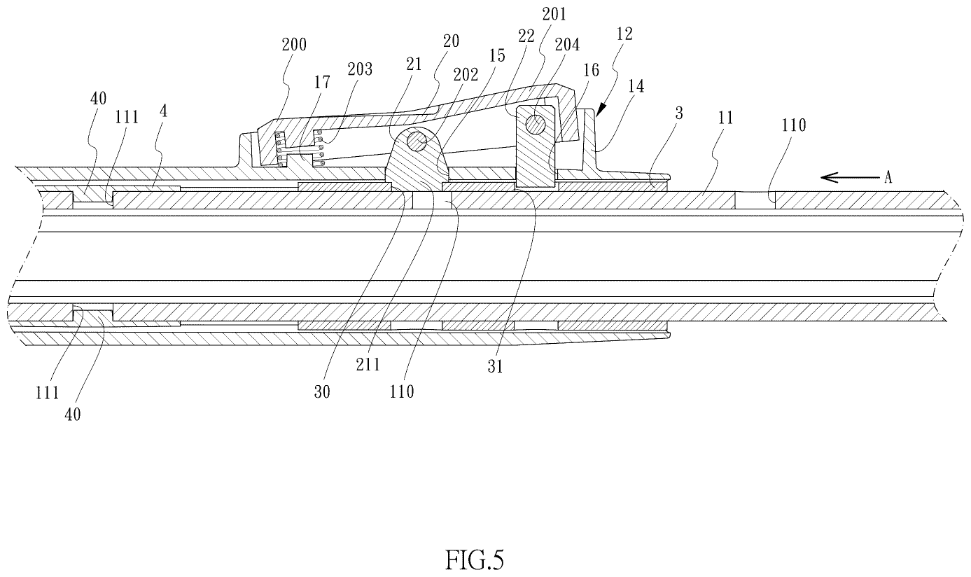

When the pressing end (200) of the actuating piece (20) is pressed downward, the resilient member (203) is compressed, causing the linking end (201) of the actuating piece (20) to pivot upward. This upward movement synchronously disengages the positioning member (22) connected to the linking end (201) from the adjustment hole (110) of the second tube (11) (as shown in FIG. 4). At this point, the limiting relationship between the first tube (10) and the second tube (11) is released, allowing the second tube (11) to telescope within the first tube (10). The second tube (11) can be adjusted and telescoped inside the first tube (10) in the direction “A” (as shown in FIG. 5).

When adjusting the telescopic movement of the second tube (11) in the direction “B”, and when the restriction member (4) of the second tube (11) reaches the sleeve (3), the second tube (11) cannot continue to move. This prevents the second tube (11) from accidentally disengaging completely from the first tube (10) and injuring the operator, thus enhancing safety during use.

When the second tube (11) and the first tube (10) are adjusted to the appropriate position, the operator releases the pressure on the pressing end (200) of the actuating piece (20). The pressing end (200) of the actuating piece (20) is then raised upward by the elastic recovery of the resilient member (203), while the linking end (201) of the actuating piece (20) pivots downward, causing the positioning member (22) to move downward. This action causes the positioning member (22) to be repositioned within another one of the adjustment holes (110) of the second tube (11). At this point, a limiting relationship is formed between the first tube (10) and the second tube (11), preventing telescopic movement. Therefore, the telescopic adjustment of the second tube (11) is controlled by operation of the control assembly (2), thereby achieving the adjustment of the overall length of the handles (1).

While we have shown and described the embodiment in accordance with the present invention, it should be clear to those skilled in the art that further embodiments may be made without departing from the scope of the present invention.

What is claimed is:

1. A telescopic handle pruning tool comprising:
two handles (1) pivotably connected to each other, each handle (1) having a first tube (10) and a second tube (11) pivotally interconnected to each other, the first tube (10) having a storage portion (12) located at a first end thereof, the storage portion (12) including a first hole (15) and a second hole (16), the second tube (11) including multiple adjustment holes (110), when the second tube (11) is telescopically moved within the first tube (10), each adjustment hole (110) of the second tube (11) is correspondingly positioned with the second hole (16) of the storage portion (12), and
a control assembly (2) located in the storage portion (12) of the first tube (10) and including an actuating piece (20), a pivot seat (21) disposed in the first hole (15) of the storage portion (12), a positioning member (22) connected to a first end of the actuating piece (20) and extending through the second hole (16) of the storage portion (12), when a second end of the actuating piece (20) is pressed downward, the first end of the actuating piece drives the positioning member (22) to move up and down, such that the positioning member (22) is engaged with or disengaged from one of the adjustment holes (110) of the second tube (11).

2. The telescopic handle pruning tool as claimed in claim 1 further comprising a sleeve (3) positioned between the first tube (10) and the second tube (11), the sleeve (3) having a first orifice (30) and a second orifice (31), a base (211) of the pivot seat (21) inserted into the first orifice (30), the positioning member (22) inserted into the second orifice (31), such that the sleeve (3) and the base (211) of the pivot seat (21) are mutually engaged and immovable.

3. The telescopic handle pruning tool as claimed in claim 1 further comprising a restriction member (4) positioned between the first tube (10) and the second tube (11), the restriction member (4) located at one end of the second tube (11), the restriction member (4) having a boss (40) corresponding to a limiting hole (111) of the second tube (11), the boss (40) of the restriction member (4) mutually engaged with the limiting hole (111) of the second tube (11) so that the restriction member (4) and the second tube (11) are moved together.

4. The telescopic handle pruning tool as claimed in claim 1, wherein the first tube (10) includes an end piece (13) located at a second end thereof and opposite to the first end of the first tube (10).

5. The telescopic handle pruning tool as claimed in claim 1, wherein one end of the second tube (11) is connected to a pruning tool (18).

6. The telescopic handle pruning tool as claimed in claim 1, wherein the storage portion (12) is surrounded by a rib (14) and has a protrusion (17).

7. The telescopic handle pruning tool as claimed in claim 6, wherein the actuating piece (20) includes a linking end (201) and a pressing end (200) respectively formed to the first end and the second end of the actuating piece (20), a pivot (202) extends through a middle of the actuating piece (2), a resilient member (203) is located at the pressing end (200) of the actuating piece (20), one end of the resilient member (203) is connected to the protrusion (17) of the storage portion (12), a rod (204) is located at the linking end (201) of the actuating piece (20).

8. The telescopic handle pruning tool as claimed in claim 7, wherein the pivot seat (21) has a pivot hole (210), the pivot (202) extends through the pivot hole (210).

9. The telescopic handle pruning tool as claimed in claim 7, wherein the positioning member (22) has a passage (220), the rod (204) extends through the passage (220).

10. The telescopic handle pruning tool as claimed in claim 7, wherein the resilient member (203) is a retractable spring.
